(19) United States
(12) Patent Application Publication
(10) Pub. No.: US 2026/0316685 A1
(43) Pub. Date: Oct. 15, 2026

(54) Strap Attachment for Personal Accessories

(71) Applicant: Julian Curtis Forman, DAHLONEGA, GA (US)

(72) Inventor: Julian Curtis Forman, DAHLONEGA, GA (US)

(21) Appl. No.: 19/173,897

(22) Filed: Apr. 9, 2025

(51) Int. Cl. B60R 7/08; B60R 11/00

(52) U.S. Cl. CPC B60R 7/08; B60R 11/00; B60R 2011/0031

(57) ABSTRACT

A device for attaching personal items to a vehicle seat belt or generic strap includes two individual plates, a base plate and a cover plate. The base plate is attached to a personal item on one side. The other side of the base plate has a guide channel on which the vehicle seat belt or generic strap may lie flat, as well as two slots along its interior walls for the cover plate to slide into. The cover plate inserts into the base plate to enclose and compress the vehicle seat belt or generic strap, creating enough friction so the device will not move, slide or shift under normal pressure.

### BACKGROUND OF THE INVENTION

### 1. Field of the Invention

The present invention is in the field of personal accessory attachment.

### 2. Description of Related Art

Many people have a few select personal items they want to access quickly while on the go, such as a mobile phone, medicines, small medical devices, and personal safety or defense items. When an urgent situation arises, however, it can be difficult to reach the item quickly, potentially resulting in inconvenience or compromised safety.

Using the example of riding in an automobile, most vehicles provide ample storage for, and accessibility to, the occupants' personal items, either by way of a center console, door pockets, cavities within the dash, and even pockets within or attached to a sun visor. However, items are typically loose and rarely secured in these storage areas, so a driver can become distracted as they search for the item with their eyes or hands. Also, in the event of an accident or a threat, these items can be thrown about the vehicle, making it difficult or impossible for them to be reached by the occupant when needed most.

Therefore, what is clearly needed is a personal attachment device that solves the problems mentioned above.

### BRIEF SUMMARY OF THE INVENTION

In one embodiment of the invention a device for attaching personal items to a vehicle seat belt or generic strap is provided, comprising two individual plates, a base plate and a cover plate, said cover plate capable of being inserted and anchored within said base plate, thereby forming a recess dimensioned to permit a vehicle seat belt or generic strap to be positioned between the base plate and cover plate, and frictionally maintain the position of the device on a captured portion of the vehicle seat belt or generic strap, the base plate having a rear edge with a partial envelope, where the side portions curl upward and return over the edges of the vehicle seat belt or generic strap almost to full closure, leaving an upwardly opened slot permitting the insertion of the vehicle seat belt or generic strap to lay flat along the elongated portion of the base plate, the base plate continuing from its rear portion from the upwardly opened slot toward its front with side portions curling up and partially returning over the edges of the vehicle seat belt or generic strap, to secure the vehicle seat belt or generic strap in a guide track, with the vehicle seat belt or generic strap being largely exposed from the top, raised ridges along the interior floor of the base plate, spanning from side to side and perpendicular to the elongated side, enhancing friction when coupled with the compressing cover plate, slotted holes located near the front of the base plate along each side wall, permitting tabs from the cover plate to lock in place when said cover plate is inserted into the guide channel at the front of the base plate, thereby securing the vehicle seat belt or generic strap by compression between the base and cover plates, said cover plate having thin arms extending from the side portions and returning parallel to the elongated sides, ending in a tab, wherein said tabs are designed to flex inward when pinched by a user, the sides of the cover plate tapering toward the outer edges to create sharp angled edges, facilitating insertion into the base plate and tightening the fit and compression as the cover plate is fully inserted into the base plate.

Also in one embodiment, the base plate comprises features that permit attachment of a personal accessory, wherein said features include holes in the base plate floor portion for attachment via screws or rivets. Also in one embodiment, the base plate comprises features that permit attachment of a personal accessory, wherein said features include configured clasps molded into the base plate, designed to securely grasp specific personal items.

### BRIEF DESCRIPTION OF THE DRAWING FIGURES

FIG. 1a is a perspective view of a base plate of a strap attachment according to an embodiment of the present invention.

FIG. 1b is an overhead view of the base plate of FIG. 1a.

FIG. 1c is a side elevation view of the base plate of FIG. 1a.

FIG. 1d is an end profile view of the base plate of FIG. 1a.

FIG. 1e is an underneath view of the base plate of FIG. 1a.

FIG. 2a is a perspective view of a cover plate of a strap attachment, according to an embodiment of the present invention.

FIG. 2b is an overhead view of the cover plate of FIG. 2a.

FIG. 3a is a perspective view of the base plate of FIG. 1a and the cover plate of FIG. 2a, according to an embodiment of the present invention.

FIG. 3b is another perspective view of the base plate of FIG. 1a and the cover plate of FIG. 2a.

FIG. 3c is an assembled view of the base plate of FIG. 1a and the cover plate of FIG. 2a.

FIG. 3d is a perspective view of the base plate of FIG. 1a, the cover plate of FIG. 2a, and a vehicle seat belt, according to a further embodiment of the present invention.

FIG. 3e is an assembled view of the base plate of FIG. 1a, the cover plate of FIG. 2a, and the vehicle seat belt of FIG. 3d, according to an embodiment of the present invention.

FIG. 3f is an assembled view of the base plate of FIG. 1a and the cover plate of FIG. 2a, and a perspective view of a person sitting in a vehicle seat secured by the vehicle seat belt of FIG. 3d, according to a further embodiment of the present invention.

FIG. 4a is a perspective view of another base plate of a strap attachment according to a further embodiment of the present invention.

FIG. 4b is an overhead overhead view of the base plate of FIG. 4a.

FIG. 4c is a perspective underneath view of the base plate of FIG. 4a

FIG. 4d is an end profile view of the base plate of FIG. 4a.

FIG. 4e is a side elevation view of the base plate of FIG. 4a.

FIG. 4f is a perspective view of the base plate of FIG. 4a, the cover plate of FIG. 2a, and the vehicle seat belt of FIG. 3d, according to a further embodiment of the present invention.

FIG. 4g is another perspective view of the base plate of FIG. 4a, the cover plate of FIG. 2a, and the vehicle seat belt of FIG. 3d.

FIG. 4h is an assembled view of the base plate of FIG. 4a, the cover plate of FIG. 2a, and the vehicle seat belt of FIG. 3d.

FIG. 4i is another assembled view of the base plate of FIG. 4a, the cover plate of FIG. 2a, and the vehicle seat belt of FIG. 3d.

FIG. 4j is an assembled view of the base plate of FIG. 4a and the cover plate of FIG. 2a, and a perspective view of a person sitting in a car seat secured by the vehicle seat belt of FIG. 3d, according to a further embodiment of the present invention.

### DETAILED DESCRIPTION OF THE INVENTION

The inventor provides a unique strap attachment device, enabling a user to securely keep select desired items close to their person. The present invention is described in enabling detail in the following examples, which may represent more than one embodiment of the present invention.

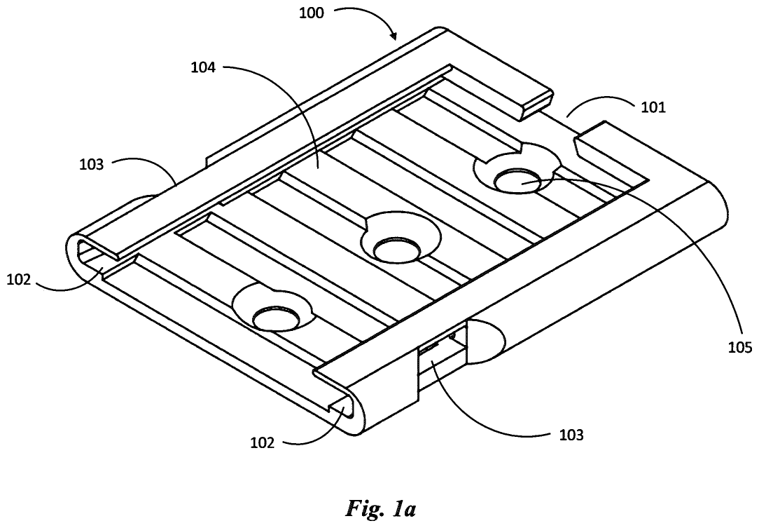

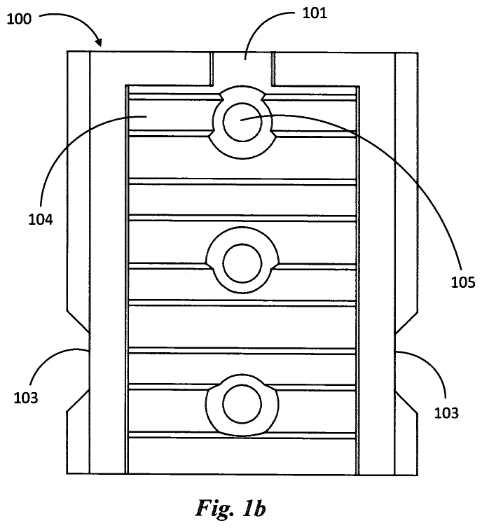

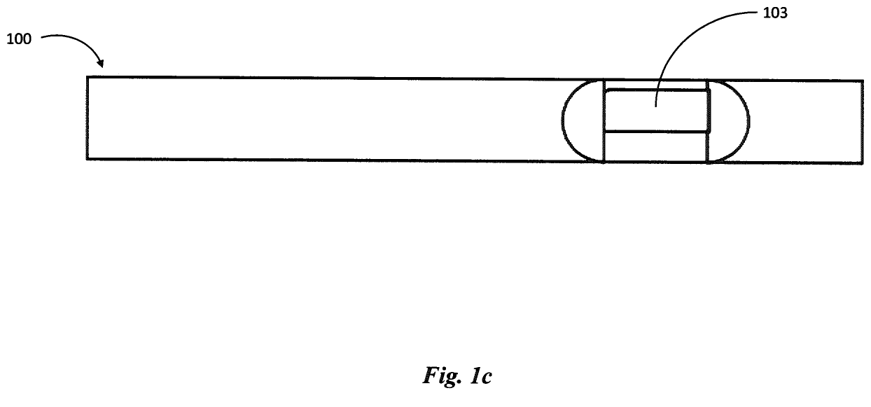

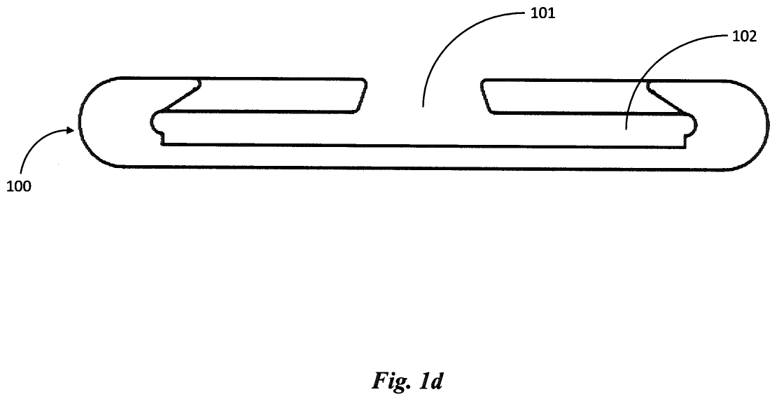

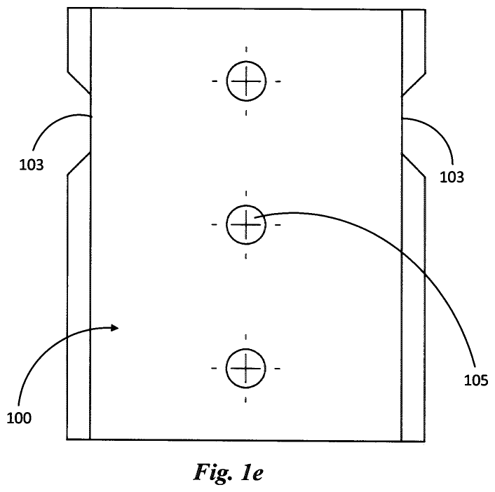

FIG. 1a is a perspective view of a base plate 100 according to an embodiment of the present invention. Base plate 100 has, in this example, a gap 101 for insertion of a vehicle seat belt or generic strap to lay lengthwise within a channel 102 that extends the length of the base plate 100. In this example, a set of raised ridges 104 within the channel 102 creates pressure points preventing or limiting the base plate 100 from sliding while attached to the vehicle seat belt or generic strap. In this example, the base plate 100 has holes 105 where screws, rivets, or other connection means can be inserted to secure the base plate 100 to a personal item of the user's choosing.

FIG. 1b is an overhead view of the base plate 100 of FIG. 1a, according to an embodiment of the present invention. This embodiment includes components that were previously introduced in FIG. 1a.

FIG. 1c is a side profile view of the base plate 100 of FIG. 1a, according to an embodiment of the present invention. This embodiment includes components that were previously introduced in FIG. 1a and FIG. 1b.

FIG. 1d is an end profile view of the bases plate 100 of FIG. 1a, according to an embodiment of the present invention. This embodiment includes components that were previously introduced in FIG. 1a, FIG. 1b and FIG. 1c. This embodiment provides a clear view on how a user can insert a vehicle seat belt or generic strap into the channel 102 by way of the gap 101.

FIG. 1e is a perspective underneath view of the base plate 100 of FIG. 1a, according to an embodiment of the present invention. This embodiment includes components that were previously introduced in FIG. 1a, FIG. 1b, FIG. 1c and FIG. 1d.

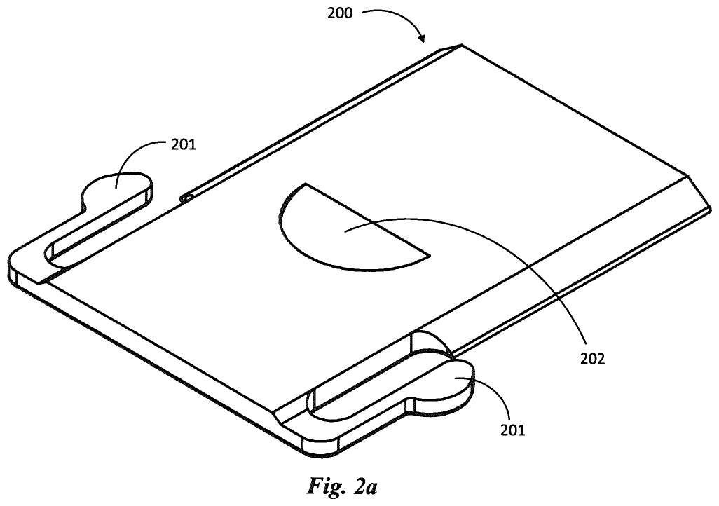

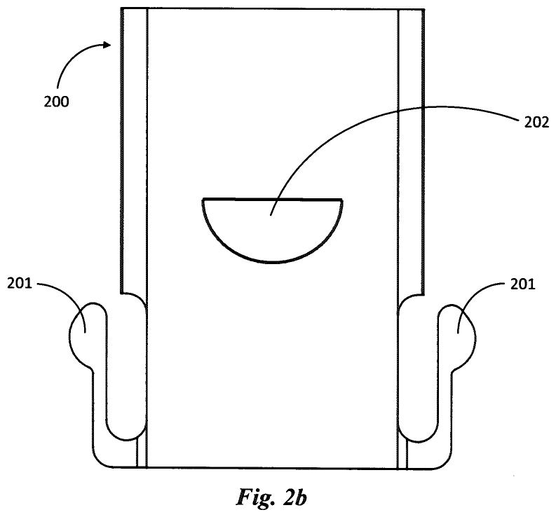

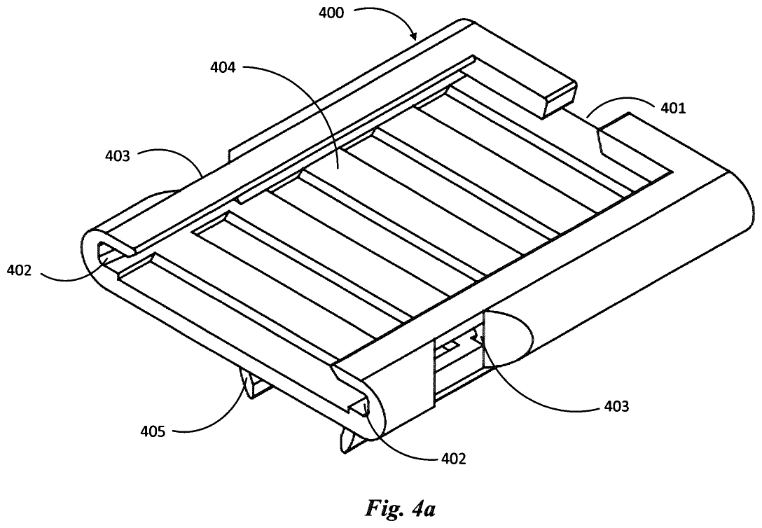

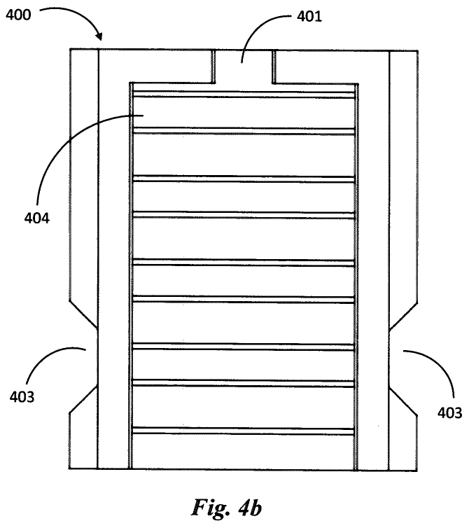

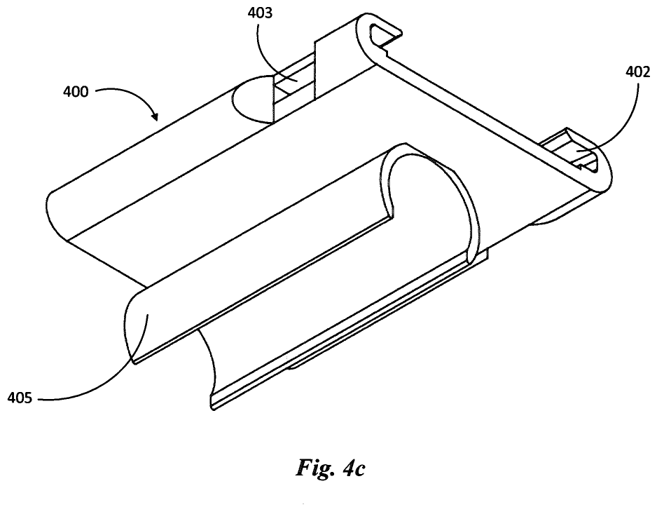

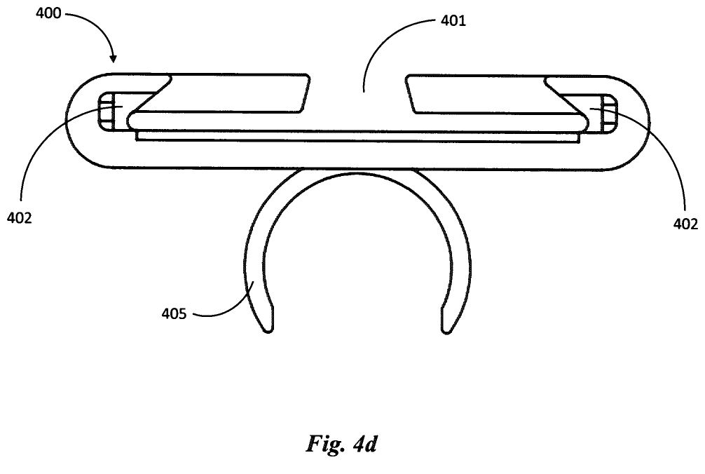

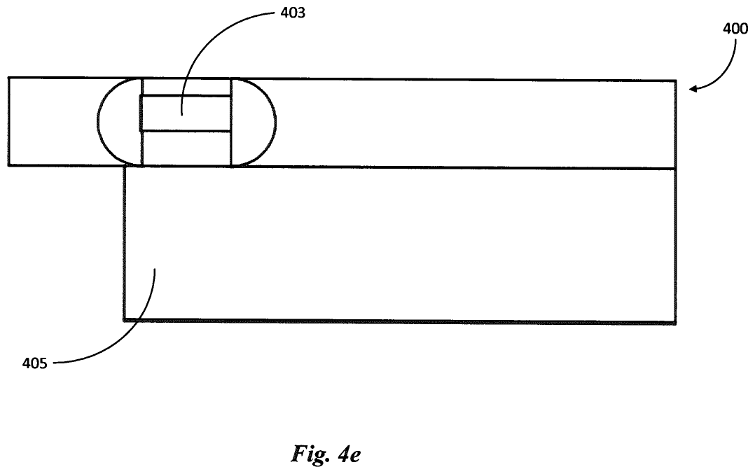

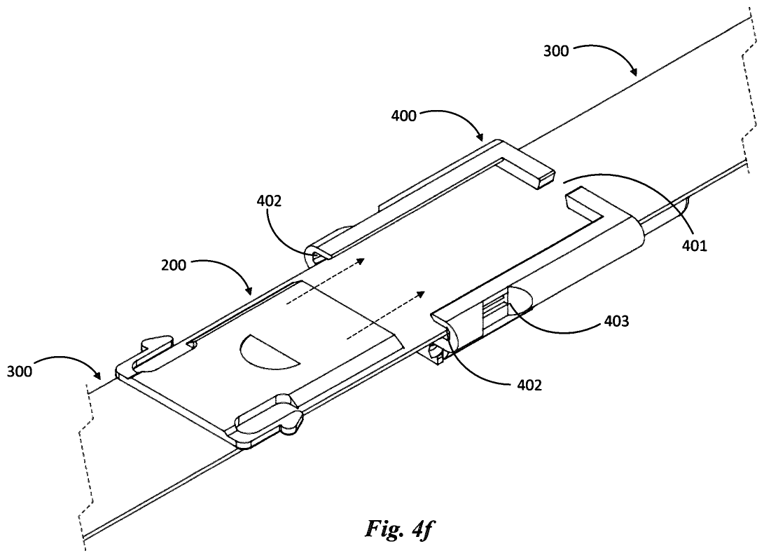

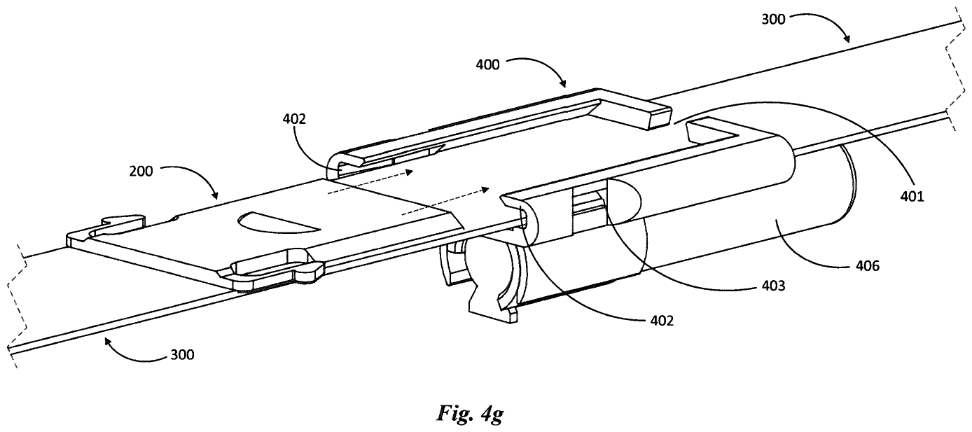

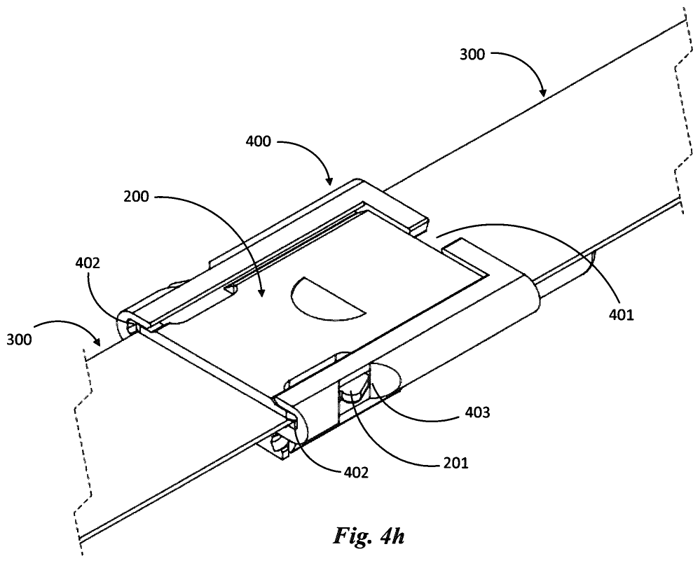

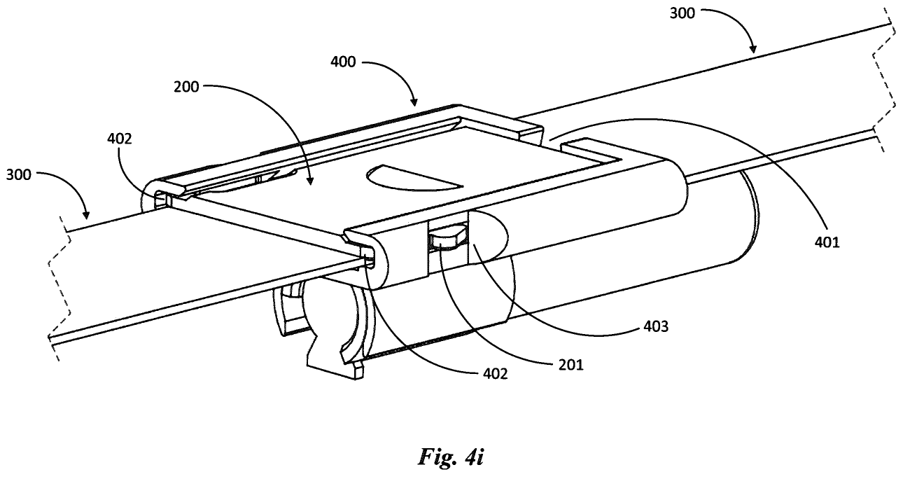

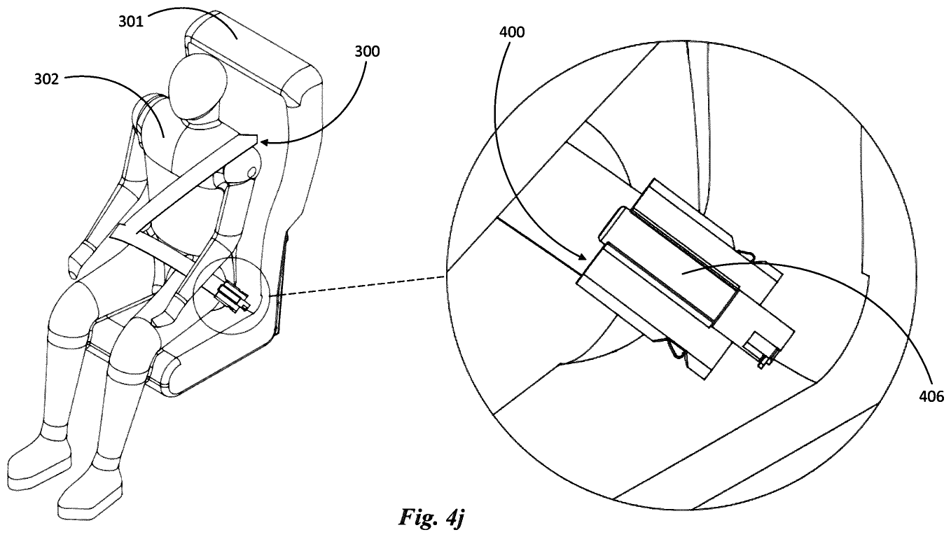

FIG. 2a is a perspective view of a cover plate 200 for use with the base plate 100 of FIG. 1a or the base plate 400 of FIG. 4a, according to an embodiment of the present invention. In this embodiment, the cover plate 200 has a tab 201 on each side which will be used for locking into the base plate 100. In this example, the cover plate 200 features an indention 202 to aid the user's grip so the user may more easily insert or remove the cover plate 200.

FIG. 2b is an overhead view of the cover plate 200 for use with base plate 100 of FIG. 1a or the base plate 400 of FIG. 4a, according to an embodiment of the present invention. This embodiment includes components that were previously introduced in FIG. 2a.

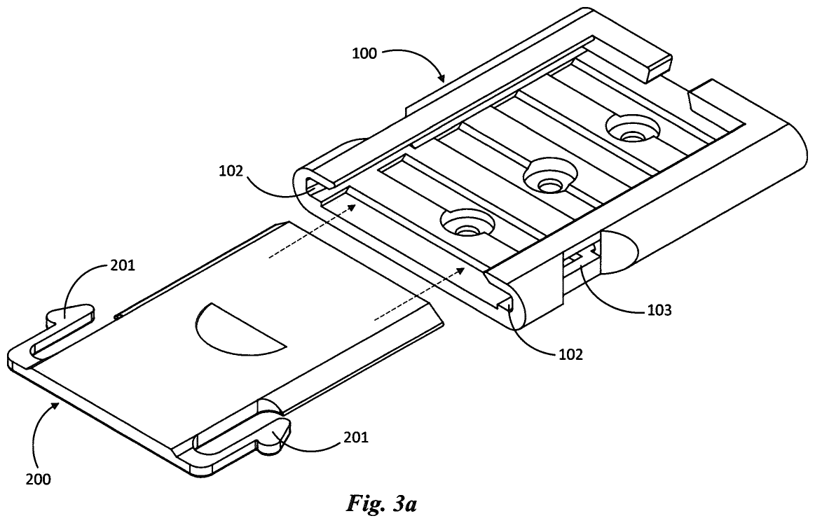

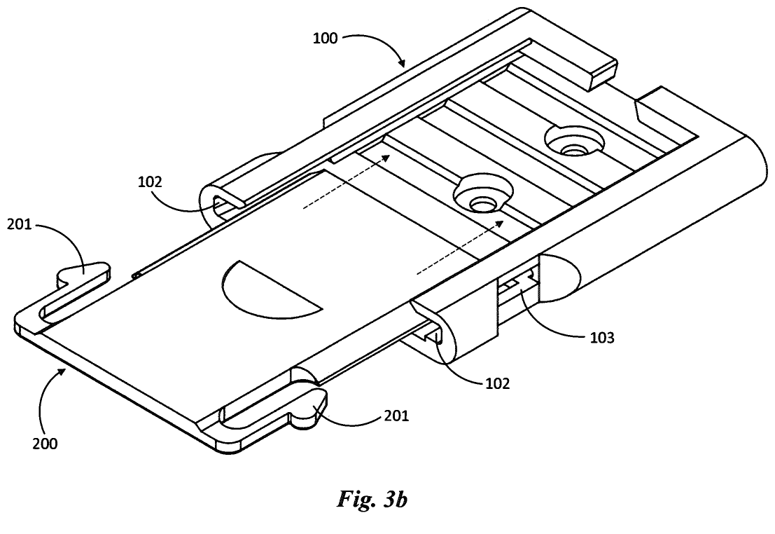

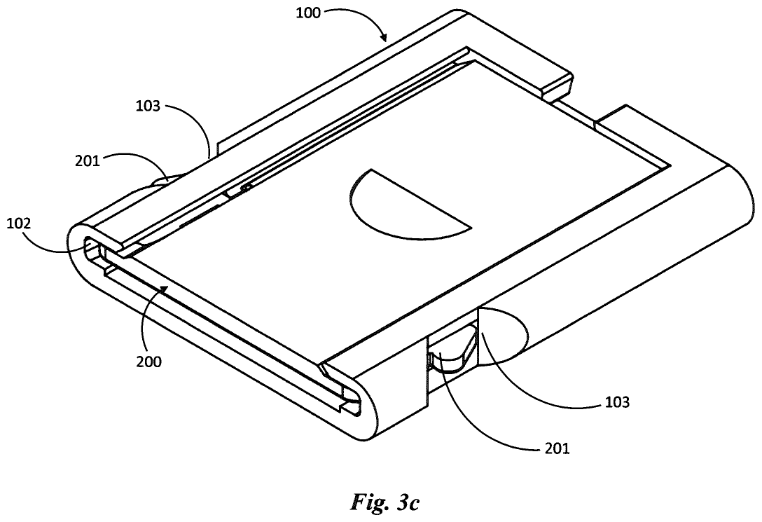

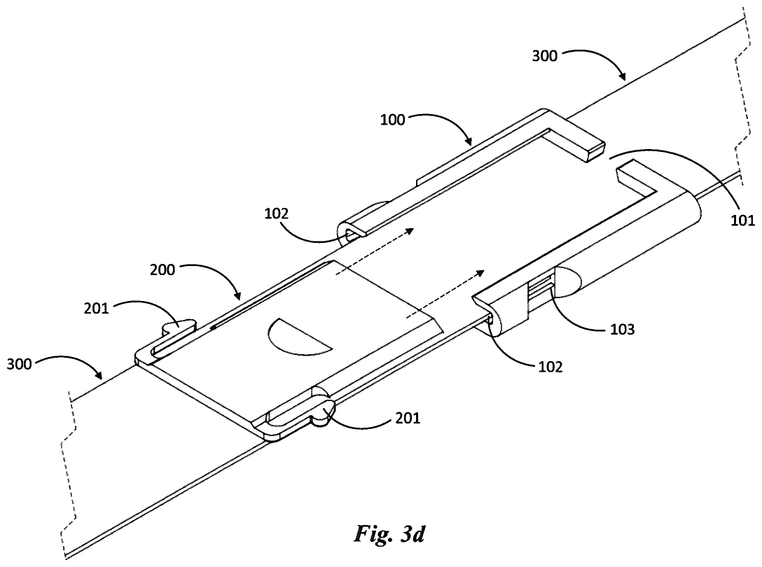

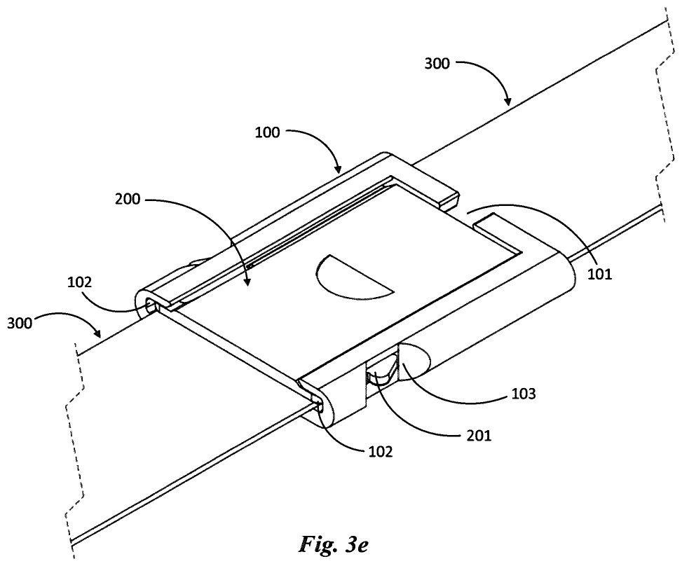

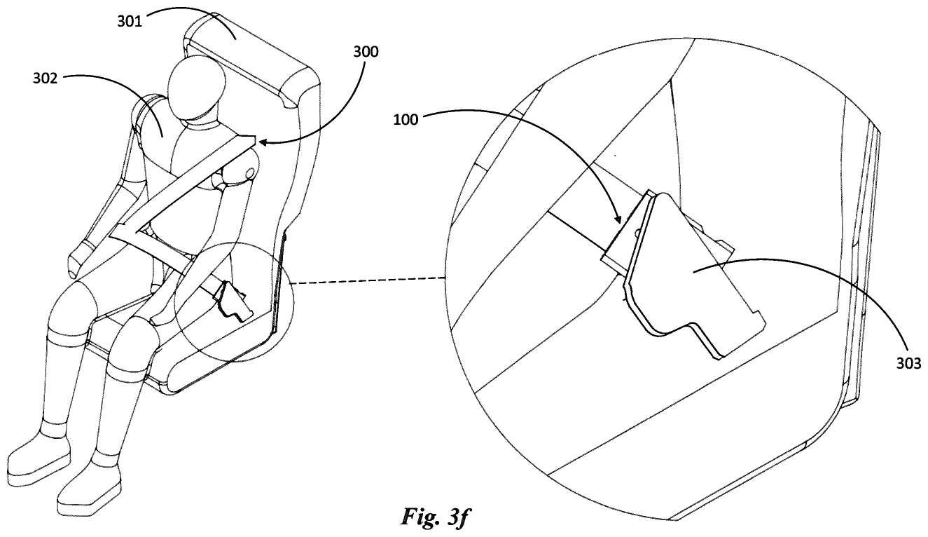

FIG. 3a is a perspective view of the base plate 100 of FIG. 1a, and a perspective view of the cover plate 200 of FIG. 2a, according to an embodiment of the present invention. This embodiment includes components that were previously introduced in FIG. 1a and FIG. 2a. In this example, the cover plate 200 is aligned to be inserted into the channel 102 of the base plate 100.

FIG. 3b is a perspective view of the base plate 100 of FIG. 1a, and a perspective view of the cover plate 200 of FIG. 2a, according to an embodiment of the present invention. This embodiment includes components that were previously introduced in FIG. 1a and FIG. 2a. In this example, the cover plate 200 is partially inserted into the channel 102 of the base plate 100.

FIG. 3c is a perspective view of the base plate 100 of FIG. 1a, and a perspective view of the cover plate 200 of FIG. 2a, according to an embodiment of the present invention. This embodiment includes components that were previously introduced in FIG. 1a and FIG. 2a. In this example, the cover plate 200 is fully inserted into the channel 102 of the base plate 100, and the tabs 201 on the cover plate 200 are locked in the slots 103 of the base plate 100, depicting a latched state.

FIG. 3d is a perspective view of the base plate 100 of FIG. 1a, a perspective view of the cover plate 200 of FIG. 2a, and a perspective view of a vehicle seat belt 300, according to an embodiment of the present invention. This embodiment includes components that were previously introduced in FIG. 1a, FIG. 2a and FIG. 3a. In this example, the vehicle seat belt 300 has been placed through the gap 101 and lays flat in the channel 102, and the cover plate 200 is aligned to be inserted into the channel 102 of the base plate 100.

FIG. 3e is another perspective view of the base plate 100 of FIG. 1a, a perspective view of the cover plate 200 of FIG. 2a, and a perspective view of the vehicle seat belt 300, according to an embodiment of the present invention. This embodiment includes components that were previously introduced in FIG. 1a, FIG. 2a, FIG. 3a and FIG. 3d. In this example, the vehicle seat belt 300 has been placed through the gap 101 of the base plate 100 and lays flat in the channel 102 of the base plate 100. In this example, the cover plate 200 has been fully inserted into the channel 102 of the base plate 100. In this example, the tabs 201 of the cover plate 200 are locked in the slots 103 of the base plate 100 depicting a latched state. In this example, the latched state between the base plate 100 and the cover plate 200 compresses the vehicle seat belt 300 against the raised ridges 104 of the base plate 100. The resulting friction prevents or limits the travel of the latched base plate 100 and the cover plate 200 along the vehicle seat belt 300.

FIG. 3f is a perspective view of a user 302 sitting in a vehicle seat 301 with the vehicle seat belt 300 latched and secured around the user 302. This embodiment includes components that were previously introduced in FIG. 1a, FIG. 2a, FIG. 3a, and FIG. 3d. In this example, the base plate 100 and the cover plate 200 are in a latched state and are secured around the vehicle seat belt 300. In this example, the base plate 100 is affixed to a firearm holster 303, which is the user's desired accessory in this example.

FIG. 4a is a perspective view of another base plate 400 according to an embodiment of the present invention. Base plate 100 has, in this example, a gap 401 for insertion of a vehicle seat belt or strap to lay lengthwise within a channel 402 that extends the length of the base plate 400. In this example, a set of raised ridges 404 within the channel 402 creates pressure points preventing or limiting the base plate 400 from sliding while attached to the vehicle seat belt or generic strap. In this example, the base plate 400 has a tubular clasp 405 that is used to secure the base plate 400 to a personal item of the user's choosing.

FIG. 4b is an overhead view of the base plate 400 of FIG. 4a, according to an embodiment of the present invention. This embodiment includes components that were previously introduced in FIG. 4a.

FIG. 4c is a perspective underneath view of the base plate 400 of FIG. 4a, according to an embodiment of the present invention. This embodiment includes components that were previously introduced in FIG. 4a and FIG. 4b. This embodiment provides a clear view of the tubular clasp 405, where a user can insert and secure a personal item of their choosing.

FIG. 4d is an end profile view of the base plate 400 of FIG. 4a, according to an embodiment of the present invention. This embodiment includes components that were previously introduced in FIG. 4a, FIG. 4b and FIG. 4c. This embodiment provides a clear view on how a user can insert a vehicle seat belt or generic strap into the channel 402 by way of the gap 401.

FIG. 4e is a side profile view of the base plate 400 of FIG. 4a, according to an embodiment of the present invention. This embodiment includes components that were previously introduced in FIG. 4a, FIG. 4b, FIG. 4c and FIG. 4d.

FIG. 4f is a perspective view of the base plate 400 of FIG. 4a, a perspective view of the cover plate 200 of FIG. 2a, and a perspective view of the vehicle seat belt 300, according to an embodiment of the present invention. This embodiment includes components that were previously introduced in FIG. 3d, FIG. 3e and FIG. 4a. In this example, the vehicle seat belt 300 has been placed through the gap 401 and lays flat in the channel 402, and the cover plate 200 is aligned to be inserted into the channel 402 of the base plate 400.

FIG. 4g is another perspective view of the base plate 400 of FIG. 4a, a perspective view of the cover plate 200 of FIG. 2a, and a perspective view of the vehicle seat belt 300, according to an embodiment of the present invention. This embodiment includes components that were previously introduced in FIG. 3d, FIG. 3e, FIG. 4a and FIG. 4f. In this example, the vehicle seat belt 300 has been placed through the gap 401 and lays flat in the channel 402, and the cover plate 200 is aligned to be inserted into the channel 402 of the base plate 400. In this example, an asthma inhaler 406 can be seen secured in the tubular clasp 405.

FIG. 4h is a perspective view of the base plate 400 of FIG. 4a, a perspective view of the cover plate 200 of FIG. 2a, and a perspective view of the vehicle seat belt 300, according to an embodiment of the present invention. This embodiment includes components that were previously introduced in FIG. 3d, FIG. 3e and FIG. 4a. In this example, the vehicle seat belt 300 has been placed through the gap 401 of the base plate 400 and lays flat in the channel 402 of the base plate 400. In this example, the cover plate 200 is fully inserted into the channel 402 of the base plate 400. In this example, the tabs 201 of the cover plate 200 are locked in the slots 403 of the base plate 400 depicting a latched state. In this example, the latched state between the base plate 400 and the cover plate 200 compresses the vehicle seat belt 300 against the raised ridges 404 of the base plate 400, which limits or prevents movement of the base plate 400 along the vehicle seat belt 300.

FIG. 4i is another perspective view of the base plate 400 of FIG. 4a, a perspective view of the cover plate 200 of FIG. 2a, and a perspective view of the vehicle seat belt 300, according to an embodiment of the present invention. This embodiment includes components that were previously introduced in FIG. 3d, FIG. 4a, FIG. 4f, FIG. 4g and FIG. 4h. In this example, the vehicle seat belt 300 has been placed through the gap 401 of the base plate 400 and lays flat in the channel 402 of the base plate 400. In this example, the cover plate 200 is fully inserted into the channel 402 of the base plate 400. In this example, the tabs 201 of the cover plate 200 are locked in the slots 403 of the base plate 400 depicting a latched state. In this example, the latched state between the base plate 400 and the cover plate 200 compresses the vehicle seat belt 300 against the raised ridges 404 of the base plate 400, which limits or prevents movement of the base plate 400 along the vehicle seat belt 300. In this example, the asthma inhaler 406 can be seen secured in the tubular clasp 405 of the base plate 400.

FIG. 4j is a perspective view of the user 302 sitting in the vehicle seat 301 with the vehicle seat belt 300 latched and secured around the user 302. This embodiment includes components that were previously introduced in FIG. 3d, FIG. 3f, FIG. 4a and FIG. 4i. In this example, the base plate 400 and the cover plate 200 are in a latched state and are secured around the vehicle seat belt 300. In this example, the user's desired accessory is the asthma inhaler 406, which is secured in the tubular clasp 405 of the base plate 400.

It will be apparent to one with skill in the art that the strap attachment of the invention may be provided using some or all of the mentioned features and components without departing from the spirit and scope of the present invention. It will also be apparent to the skilled artisan that the embodiments described above are specific examples of a single broader invention which may have greater scope than any of the singular descriptions taught. There may be many alterations made in the descriptions without departing from the spirit and scope of the present invention.

1-3. (canceled)

4. A strap-mounted accessory support device comprising:
a base member comprising a floor and opposed side portions defining a longitudinal channel configured to receive a portion of a strap;
a retaining member configured to be received at least partially within the longitudinal channel;
a releasable latching arrangement configured to retain the retaining member relative to the base member in a captured configuration in which the portion of the strap is retained between the floor of the base member and the retaining member and movement of the strap-mounted accessory support device along the strap is resisted; and
an accessory attachment structure coupled to or integral with the base member and configured to support a personal accessory or an accessory holder.

5. The strap-mounted accessory support device of claim 4, wherein the retaining member is configured to be slidably inserted into the longitudinal channel in a direction substantially parallel to a longitudinal direction of the strap.

6. The strap-mounted accessory support device of claim 4, wherein the releasable latching arrangement comprises:
a pair of resilient arms disposed on opposite sides of the retaining member;
a respective tab disposed on each of the resilient arms; and
a pair of slots disposed in the opposed side portions of the base member and configured to receive the respective tabs when the retaining member is in the captured configuration.

7. The strap-mounted accessory support device of claim 6, wherein the resilient arms are configured to deflect inwardly to disengage the respective tabs from the pair of slots and permit removal of the retaining member from the base member.

8. The strap-mounted accessory support device of claim 4, wherein the floor of the base member comprises a plurality of raised ridges positioned to engage the portion of the strap when the retaining member is in the captured configuration.

9. The strap-mounted accessory support device of claim 8, wherein the raised ridges extend transversely relative to the longitudinal channel.

10. The strap-mounted accessory support device of claim 4, wherein the opposed side portions comprise respective retaining portions extending over respective longitudinal edge portions of the strap when the portion of the strap is received within the longitudinal channel.

11. The strap-mounted accessory support device of claim 4, wherein the accessory attachment structure comprises one or more openings extending through the floor of the base member and configured to receive one or more fasteners for securing the personal accessory or the accessory holder to the base member.

12. The strap-mounted accessory support device of claim 4, wherein the accessory attachment structure comprises a clasp integral with the base member and configured to releasably receive the personal accessory.

13. A personal-accessory positioning system comprising:
a strap;
a strap-mounted attachment device comprising:
a base member comprising a floor and opposed side portions defining a longitudinal channel receiving a portion of the strap;
a cover member received at least partially within the longitudinal channel;
a releasable latch retaining the cover member relative to the base member in a captured configuration in which the portion of the strap is retained between the floor of the base member and the cover member and movement of the strap-mounted attachment device along the strap is resisted; and
an accessory attachment structure coupled to or integral with the base member; and
a personal accessory or an accessory holder supported by the accessory attachment structure.

14. The personal-accessory positioning system of claim 13, wherein the strap is a vehicle seat belt configured to extend across an occupant seated in a vehicle seat.

15. The personal-accessory positioning system of claim 13, wherein:
the accessory attachment structure comprises one or more openings extending through the base member; and
the personal accessory or the accessory holder is secured to the base member by one or more fasteners extending through the one or more openings.

16. The personal-accessory positioning system of claim 13, wherein:
the accessory attachment structure comprises a tubular clasp integral with the base member; and
at least a portion of the personal accessory is releasably received within the tubular clasp.

17. The personal-accessory positioning system of claim 16, wherein the personal accessory comprises a medical device having a generally cylindrical portion received within the tubular clasp.

18. A method of positioning a personal accessory on a strap, the method comprising:
positioning a portion of the strap within a longitudinal channel defined by a floor and opposed side portions of a base member;
moving a retaining member at least partially into the longitudinal channel;
releasably latching the retaining member to the base member in a captured configuration in which the portion of the strap is retained between the floor of the base member and the retaining member, thereby resisting movement of the base member along the strap; and
supporting the personal accessory or an accessory holder with an accessory attachment structure coupled to or integral with the base member.

19. The method of claim 18, wherein:
positioning the portion of the strap within the longitudinal channel comprises introducing the portion of the strap through an opening between opposed retaining portions of the base member; and
moving the retaining member comprises sliding the retaining member along the longitudinal channel in a direction substantially parallel to a longitudinal direction of the strap.

20. The method of claim 18, wherein releasably latching the retaining member comprises engaging respective tabs carried by a pair of resilient arms of the retaining member with respective slots formed in the opposed side portions of the base member.
